(19) United States
(12) Patent Application Publication
(10) Pub. No.: US 2008/0037421 A1
(43) Pub. Date: Feb. 14, 2008

(54) State transitions in flow control protocol

(75) Inventor: Seung-June Yi, Seoul (KR)

Correspondence Address: L. Howard Chen, Esq.;Kirkpatrick & Lockhart Preston Gates Ellis LLP, Suite 1700, 55 Second Street, San Francisco, CA, 94105, US

(73) Assignee: VIA Telecom Co., Ltd.

(21) Appl. No.: 11/482,649

(22) Filed: Jul. 7, 2006

(51) Int. Cl. H04L 12/26

(52) U.S. Cl. 370/230

(57) ABSTRACT

A method and system for transitioning a flow control protocol (FCP) in an access terminal (AT-FCP) from an Open state to a Close state when a transmission-off response (XoffResponse) message gets lost during a transmission, the method and system comprising sending a first transmission-off request (XoffRequest) message by the AT-FCP, measuring time upon sending the first XoffRequest message, and transitioning the AT-FCP to the Close state when a predetermined length of time has elapsed since sending the first XoffRequest message, alternatively, the method comprising sending at least one XoffResponse message by a FCP in an access network (AN-FCP) every time a transmission-off request (XoffRequest) message is received by the AN-FCP regardless of the AN-FCP is in the Open state or the Close state.

### BACKGROUND

The present invention relates generally to communication protocols, and more particularly, to the state transitions in flow control protocol.

Flow Control Protocol (FCP) is one of the application layer protocols of High Rate Packet Data (HRPD) system that provides procedures and messages used by an access terminal and an access network to perform flow control for the packet application. The access terminal implements FCP as does the access network. The FCPs for both the access terminal and the access network works in tandem to perform flow control of data transmission between the access terminal and the access network. The FCPs have two states: a Close state and an Open state. In the Open state, the packet application is allowed to send or receive data packets, but in the Close state, the data transmission is prohibited.

The FCPs are initially in Close states, in which the packet application does not send or receive any data packets. The state transition procedure from a Close to an Open state is different depending on initiatives of the transition.

When the access network wants to transition its FCP from the Close state to the Open state, the FCP of the access network (hereafter, AN-FCP) first sends a DataReady message to the FCP of the access terminal (hereafter, AT-FCP) to indicate that there is data corresponding to this Packet Application waiting to be transmitted. When the AT-FCP receives the DataReady message, it checks the access terminal's resource and flow status, and sends a XonRequest (transmission-on request) message to the AN-FCP if the access terminal is ready to exchange data packets. The AT-FCP transitions to the Open state when it sends a XonRequest message. When the AN-FCP receives the XonRequest message, the AN-FCP sends a XonResponse (transmission-on response) message to the AT-FCP, and also transitions to the Open state. Now both access terminal and access network are in Open state, hence the data transmission is allowed.

When the access terminal wants to initiate the message exchanges and transition its FCP from the Close state to the Open state, the access terminal just sends data packet without exchanging XonRequest/XonResponse messages. The AT-FCP transitions to the Open state when the access terminal sends any data packet in Close state, and the AN-FCP transitions to the Open state when the access network receives any data packet in Close state.

When the data transmission is completed or needs to be suspended, the AT-FCP sends a XoffRequest (transmission-off request) message to the AN-FCP. Upon receiving the XoffRequest message, the AN-FCP sends a XoffResponse (transmission-off response) message to the AT-FCP to acknowledge the reception of the XoffRequest message, and transitions to the Close state. But the AT-FCP transitions to the Close state only after it receives the XoffResponse message.

Traditionally, for the provision of missing of messages, the access terminal retransmits a XoffRequest message if it does not receive a XoffResponse message within the pre-defined time period TXoff after sending the XoffRequest message. To do this, the AT-FCP starts a timer of the period TXoff when it sends a XoffRequest message. If the access terminal does not receive a XoffResponse message when the period TXoff expires, the AT-FCP retransmits a XoffRequest message and restarts the timer. The access terminal keeps retransmitting a XoffRequest message until it receives a XoffResponse message, and the AT-FCP transitions to the Close state only after the reception of the XoffResponse message.

In cases when a XoffRequest message is correctly transmitted but a XoffResponse message is lost during transmission, the AT-FCP keeps retransmitting XoffRequest messages. Since the AN-FCP has already transitioned to the Close state after transmitting the XoffResponse message, the AN-FCP will not receive or respond to further XoffRequest messages. As a consequence, the AT-FCP is stuck in the Open state and keeps retransmitting XoffRequest messages in vain.

What is needed is a method and system for releasing the access terminal from being stuck in the Open state when the XoffRequest message is lost.

### SUMMARY

In view of the foregoing, a method for transitioning a flow control protocol (FCP) in an access terminal (AT-FCP) from an Open state to a Close state when a transmission-off response (XoffResponse) message gets lost during a transmission is disclosed. The method comprises sending a first transmission-off request (XoffRequest) message by the AT-FCP, measuring time upon sending the first XoffRequest message, and transitioning the AT-FCP to the Close state when a predetermined length of time has elapsed since sending the first XoffRequest message. An alternative method comprises sending at least one XoffResponse message by a FCP in an access network (AN-FCP) every time a transmission-off request (XoffRequest) message is received by the AN-FCP regardless if the AN-FCP is in an Open state or a Close state.

The aforementioned two methods can also be combined, i.e., the AT-FCP starts measuring time after sending a first XoffRequest message, the AN-FCP sends a XoffResponse message whenever a XoffRequest message is received, and the AT-FCP transitions to the Close state after either a predetermined length of time has elapsed or a XoffResponse has been received.

An embodiment of this invention is to provide a flow control protocol (FCP) implemented system for preventing meaningless waiting for a transmission-off response (XoffResponse) message by a FCP in an access terminal (AT-FCP), wherein the XoffResponse message sent from a FCP in an access network (AN-TCP) is lost during transmission. The FCP implemented system comprising components being selected from a combination of group of: the access terminal is configured to transition the AT-FCP to a Close state when a predetermined length of time has elapsed since sending a first transmission-off request (XoffRequest) message to the AN-FCP; and the AN-FCP is configured to sending the XoffResponse message whenever a XoffRequest is received.

Another embodiment of this invention is to provide an access terminal, which comprises a flow control protocol (FCP) for sending a first transmission-off request (XoffRequest) message; and a first timer configured to start upon the sending of the first XoffRequest message and informing the FCP to transition to a Close state when a predetermined length of time has elapsed.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flow chart illustrating a conventional access terminal flow control protocol (AT-FCP) being stuck in an Open state.

FIG. 2 is a flow chart illustrating an access network sending a transmission-off response (XoffResponse) message after being transitioned to the Close state according to one embodiment of the present invention.

FIG. 3 is a flow chart illustrating an access terminal transitioned to the Close state after repeatedly not receiving a transmission-off response message according to another embodiment of the present invention.

FIG. 4 is a block diagram illustrating a High Rate Packet Data (HRPD) system with an access network and an access terminal having a counter for measuring time according to the embodiments of the present invention shown in FIGS. 2 and 3.

### DESCRIPTION

The present disclosure discusses system and method for releasing a flow control protocol (FCP) in an access terminal from an Open state to a Close state when a transmission-off response (XoffResponse) message sent by a corresponding access network is lost.

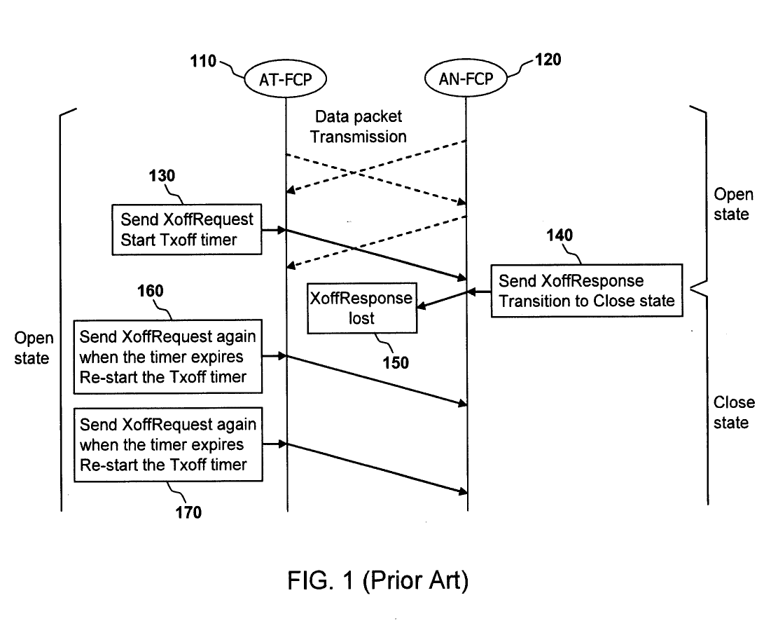

FIG. 1 is a flow chart illustrating a FCP in a conventional access terminal (AT-FCP) 110 being stuck in an Open state when a XoffResponse message sent by a corresponding FCP in an access network (AN-FCP) 120 is lost. Initially both the AT-FCP 110 and AN-FCP 120 are in the Open state, when data packets can be transmitted between them. Then the AT_FCP 110 sends a transmission-off request (XoffRequest) to the AN-FCP 120 in step 130. The AT-FCP also starts a timer, Txoff, in step 130. Upon receiving the XoffRequest message, the AN-FCP 120 sends a transmission-off response (XoffResponse) back to the AT-FCP 110, and then transitions to the Close state in step 140. But the XoffResponse message is lost during a transmission in step 150 and will never be received by the AT-FCP 110. The Txoff timer expires in step 160. Without receiving a XoffResponse message, the AT-FCP 110 sends another XoffRequest message to the AN-FCP 120, and re-starts the timer Txoff in step 160. In step 170, the Txoff timer of the AT-FCP 110 expires another time without receiving any XoffResponse message, and the AT-FCP 110 keeps sending XoffRequest messages. In such conventional flow control protocol (FCP) system, once a XoffResponse message is lost, the AT-FCP 110 has no way to receive another one or turn itself into the Close state.

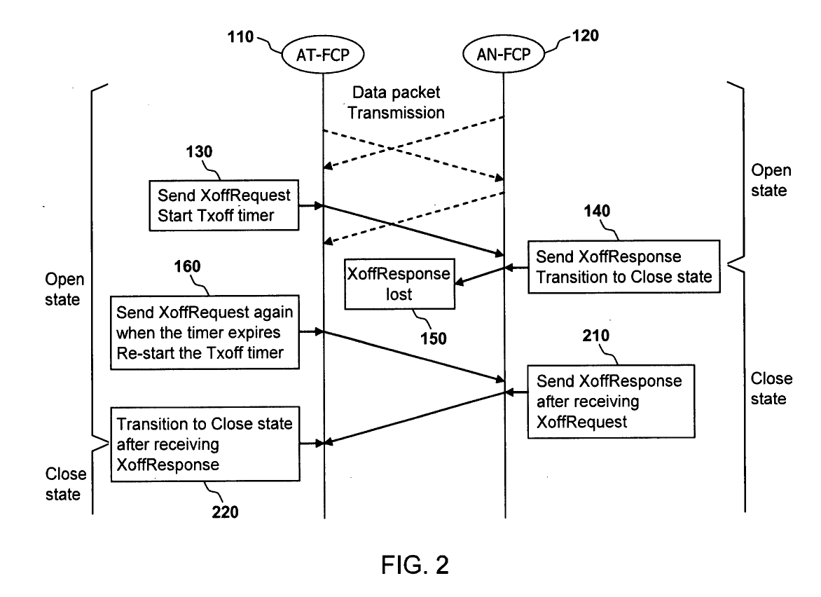

FIG. 2 is a flow chart illustrating an AN-FCP 120 sending a transmission-off response after transitioned to the Close state according to one embodiment of the present invention. Like elements in both FIGS. 1 and 2 are labeled with like reference numbers and are therefore not discussed again. In step 210, the AN-FCP 120 sends a new XoffResponse message after receiving a new XoffRequest message even though the AN-FCP 120 has already transitioned into the Close state. The new XoffResponse message reached the AT-FCP 110 this time. Upon receiving the XoffResponse message, the AT-FCP 110 transitions to the Close state.

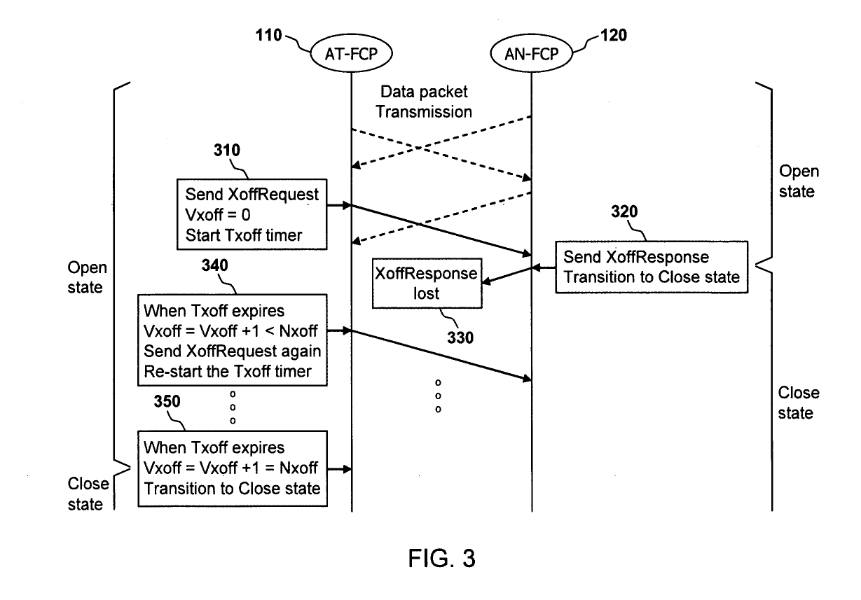

FIG. 3 is a flow chart illustrating an AT-FCP 110 transitioning to the Close state after repeatedly not receiving a XoffResponse message according to another embodiment of the present invention. The AT-FCP 110 set a counter Vxoff=0 when sending a XoffRequest message and starting a Txoff timer in step 310. The AN-FCP 120 sends a XoffResponse message upon receiving the XoffRequest message in step 320. But the XoffResponse message gets lost during transmission in step 330. When the Txoff timer expires in step 340, the AT-FCP 110 increments the counter Vxoff=Vxoff+1. If Vxoff is smaller than a predetermined number Nxoff, the AT-FCP 110 sends another XoffRequest message and re-starts the Txoff timer. The AT-FCP 110 will not receive any XoffResponse message according to this embodiment of the present invention, so step 340 keeps repeating until the counter Vxoff is increased to Vxoff=Vxoff+1=Nxoff, then the AT-FCP 110 stops sending XoffRequest or re-starting the Txoff timer, but transitions to the Close state in step 350. In essence, the counter Vxoff is to limit the amount of time the AT-FCP 110 waits for a XoffResponse message before transitioning to the Close state.

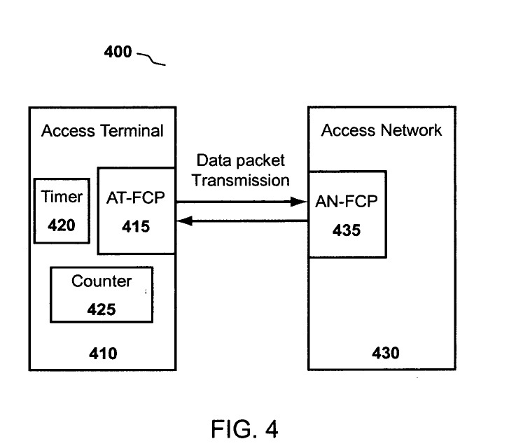

FIG. 4 is a block diagram illustrating a High Rate Packet Data (HRPD) system 400 with an access network 430 and an access terminal 410 having a counter 425 for measuring time according to the embodiments of the present invention shown in FIGS. 2 and 3. The access terminal 410 also has an AT-FCP 415 and a timer 420 for control timing when sending repeated XoffRequest messages. The counter 425 is configured for measuring the total length of time the AT-FCP 415 is allowed to wait for a XoffResponse message before transitioning to the Close state according to the embodiment of the present invention shown in FIG. 2. When sending a first XoffRequest message to the access network 430, the AT-FCP 415 also starts the timer 420 and resets the counter 425 to a predetermined first number, for instance, zero. When the timer 420 expires and no XoffResponse message is received, the AT-FCP 415 increments the counter 425 by a predetermined second number, for instance, one. If the counter has not reach a predetermined third number, two, for instance, then the AT-FCP 415 will send another XoffRequest message, and start the timer 420 again. The access terminal repeats the above steps until the counter 425 has reached the predetermined third number, i.e., two, then the AT-FCP 415 will transition to the Close state. In essence, the combination of the timer 420 and the counter 425 represents a way to measure the time the AT-FCP 415 is allowed to wait for a XoffResponse message before transitioning itself to the Close state.

Referring to FIG. 4, when the AN-FCP 435 receives a XoffRequest message in an Open state, it will transition to a Close state, and will send a XoffResponse message. When the AN-FCP 435 receives a XoffRequest message in a Close state, it will remain in the Close state, and still will send a XoffResponse message according to the embodiment of the present invention shown in FIG. 3, so that even when a previous XoffResponse message gets lost in transmission, the AN-FCP can always send another XoffResponse so that the AT-FCP will never be stuck in an Open state.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method for transitioning a flow control protocol (FCP) in an access terminal (AT-FCP) from an Open state to a Close state when a transmission-off response (XoffResponse) message gets lost during a transmission, the method comprising:
sending a first transmission-off request (XoffRequest) message by the AT-FCP;
measuring time upon sending the first XoffRequest message; and
transitioning the AT-FCP to the Close state when a predetermined length of time has elapsed since sending the first XoffRequest message.

2. The method of claim 1 further comprising transitioning the AT-FCP to the Close state upon receiving a XoffResponse message regardless of the time measured.

3. The method of claim 1 further comprising sending a series of XoffRequest messages by the AT-FCP subsequent to the first XoffRequest message in at least one predetermined time interval before the AT-FCP transitions to the Close state.

4. The method of claim 3 further comprising:
resetting at least one counter to a first predetermined number upon sending the first XoffRequest message;
incrementing the counter by a second predetermined number every time the AT-FCP sends a subsequent XoffRequest message; and
informing the AT-FCP that the predetermined length of time has been reached when the counter is equal or larger than a third predetermined number.

5. The method of claim 3 further comprising:
resetting at least one counter to a first predetermined number upon sending the first XoffRequest message;
decrementing the counter by a second predetermined number every time the AT-FCP sends a XoffRequest message; and
informing the AT-FCP that the predetermined length of time has been reached when the counter is equal or larger than a third predetermined number.

6. An access terminal, comprising:
a flow control protocol (FCP) for sending a first transmission-off request (XoffRequest) message; and
a first timer configured to start upon the sending of the first XoffRequest message and informing the FCP to transition to a Close state when a predetermined length of time has elapsed.

7. The access terminal of claim 6 further comprising at least one second timer for generating at least one time interval between sending adjacent two of a series of XoffRequest messages.

8. The access terminal of claim 7, wherein the first timer is a counter being reset to a predetermined first number upon sending the first XoffRequest message, incrementing by a second predetermined number every time a XoffRequest message is being sent and sending a transition signal to the FCP when a third predetermined number has been reached.

9. The access terminal of claim 7, wherein the first timer is a counter being reset to a predetermined first number upon sending the first XoffRequest message, decrementing by a second predetermined number every time an XoffRequest message is being sent and sending a transition signal to the FCP when a third predetermined number has been reached.

10. A method for transitioning a flow control protocol (FCP) in an access terminal (AT-FCP) from an Open state to a Close state when a transmission-off response (XoffResponse) message gets lost during transmission, the method comprising sending at least one XoffResponse message by a FCP in an access network (AN-FCP) every time a transmission-off request (XoffRequest) message is received by the AN-FCP regardless of the AN-FCP is in an Open state or a Close state.

11. The method of claim 10 further comprising:
transitioning the AN-FCP to the Close state from the Open state after receiving the XoffRequest message by the AN-FCP; and
remaining the AN-FCP in the Close state after receiving the XoffRequest message by the AN-FCP.

12. A flow control protocol (FCP) implemented system for preventing meaningless waiting for a transmission-off response (XoffResponse) message by a FCP in an access terminal (AT-FCP), wherein the XoffResponse message sent from a FCP in an access network (AN-TCP) lost during transmission, the FCP implemented system comprising components being selected from a combination of group of:
the access terminal is configured to transition the AT-FCP to a Close state when a predetermined length of time has elapsed since sending a first transmission-off request (XoffRequest) message to the AN-FCP; and
the AN-FCP is configured to sending the XoffResponse message whenever a XoffRequest is received.

13. The FCP implemented system of claim 12, wherein the access terminal further comprises a first timer configured to being started upon the sending of the first XoffRequest message and informing the AT-FCP to transition to a Close state when a predetermined length of time has elapsed.

14. The FCP implemented system of claim 13, wherein the access terminal further comprising at least one second timer for generating at least one time interval between sending adjacent two of a series of XoffRequest messages.

15. The FCP implemented system of claim 14, wherein the first timer is a counter being reset to a predetermined first number upon sending the first XoffRequest message, incrementing by a second predetermined number every time a XoffRequest message being sent, and sending a transition signal to the AT-FCP when a third predetermined number has been reached.

16. The FCP implemented system of claim 14, wherein the first timer is a counter being reset to a predetermined first number upon sending the first XoffRequest message, decrementing by a second predetermined number every time a XoffRequest message being sent, and sending a transition signal to the AT-FCP when a third predetermined number has been reached.

17. The FCP implemented system of claim 12, wherein the AN-FCP is further configured to:
transitioning to the Close state from the Open state after receiving the XoffRequest message; and
remaining in the Close state after receiving the XoffRequest message.
